(19) United States
(12) Patent Application Publication
(10) Pub. No.: US 2026/0248193 A1
(43) Pub. Date: Aug. 27, 2026

(54) AEROSOL GENERATION DEVICE

(71) Applicant: KT&G CORPORATION, Daejeon (KR)

(72) Inventors: Jaemin LEE, Gyeonggi-do (KR); Sang Kyu PARK, Seoul (KR); Sang Joon KIM, Gyeonggi-do (KR); Se Hwan JUNG, Gyeonggi-do (KR)

(73) Assignee: KT&G CORPORATION, Daejeon (KR)

(21) Appl. No.: 19/159,392

(22) PCT Filed: Jun. 11, 2024
(86) PCT No.: PCT/KR2024/007926

§ 371 Date: Aug. 25, 2025

(30) Foreign Application Priority Data
Jul. 6, 2023 (KR) 10-2023-0087672
Aug. 29, 2023 (KR) 10-2023-0113546

(51) Int. Cl. A24F 40/465; A24F 40/50; H05B 6/10

(52) U.S. Cl. CPC A24F 40/465; A24F 40/50; H05B 6/108

(57) ABSTRACT

An aerosol generation device according to an embodiment may comprise: a body having an inner space into which an aerosol-generating article is inserted from one surface of the body; a susceptor accommodated in the body to heat the aerosol-generating article; an induction coil surrounding the susceptor to generate an alternating magnetic field; and a control unit controlling operations of the aerosol generation device and including at least one processor, wherein the susceptor includes a hollow portion for increasing inductance of the susceptor during heating.

### TECHNICAL FIELD

The present disclosure relates to an aerosol generating device.

### BACKGROUND ART

Research on non-combusted cigarettes is being carried out. An aerosol generating device generates an aerosol by heating an aerosol generating article. To heat a cigarette using an inductive heating method, an electronic cigarette device may generate an alternating magnetic field using a coil to generate an eddy current in a susceptor adjacent to the cigarette. The temperature of the susceptor may increase due to the eddy current generated in the susceptor.

The above description is information the inventor(s) acquired during the course of conceiving the present disclosure, or already possessed at the time, and is not necessarily art publicly known before the present application was filed.

### DISCLOSURE OF THE INVENTION

### Technical Goals

An embodiment is to provide an aerosol generating device that may increase inductance change of a susceptor during induction heating.

An embodiment is to provide an aerosol generating device that may increase temperature measurement accuracy of a susceptor during induction heating.

The technical goals obtainable from the embodiments are non-limited by the above-mentioned technical goals, and other unmentioned technical goals can be clearly understood from the following description by one of ordinary skill in the art.

### Technical Solutions

According to an embodiment, an aerosol generating device includes a body having an internal space formed into which an aerosol generating article is inserted on one side, a susceptor accommodated in the body and configured to heat the aerosol generating article, an induction coil surrounding the susceptor and configured to generate an alternating magnetic field, and a controller configured to control an operation of the aerosol generating device and including at least one processor, wherein the susceptor may include a hollow portion configured to increase inductance of the susceptor when heated.

According to an embodiment, an aerosol generating device includes a body having an internal space formed into which an aerosol generating article is inserted on one side, a susceptor accommodated in the body and configured to heat the aerosol generating article, an induction coil surrounding the susceptor and configured to generate an alternating magnetic field, and a controller configured to control an operation of the aerosol generating device and including at least one processor, wherein screw threads may be formed on a surface of the susceptor so that inductance may be increased when the susceptor is heated.

### Effects of the Invention

According to at least one of the embodiments of the present disclosure, an aerosol generating device that may increase inductance change of a susceptor during induction heating may be provided.

According to at least one of the embodiments of the present disclosure, an aerosol generating device that may increase temperature measurement accuracy of a susceptor during induction heating may be provided.

The effects of the aerosol generating device according to an embodiment are not limited to the above-mentioned effects, and other unmentioned effects can be clearly understood from the following description by one of ordinary skill in the art.

### BRIEF DESCRIPTION OF DRAWINGS

FIG. 1 is a diagram illustrating an aerosol generating device according to an embodiment.

FIG. 2 is a block diagram illustrating an aerosol generating device according to an embodiment.

FIGS. 3A and 3B are schematic diagrams illustrating a susceptor of an aerosol generating device, according to an embodiment.

FIG. 4 is a diagram illustrating an aerosol generating device according to an embodiment.

FIG. 5 is a diagram illustrating an aerosol generating device according to an embodiment.

FIG. 6 is a schematic diagram illustrating a susceptor of an aerosol generating device, according to an embodiment.

FIG. 7 is a diagram illustrating an eddy current trajectory in a susceptor represented by a frequency of a signal, according to an embodiment.

FIG. 8 is a diagram illustrating an aerosol generating device according to an embodiment.

FIG. 9 is a diagram illustrating an aerosol generating device according to an embodiment.

FIG. 10 is a diagram illustrating an aerosol generating device according to an embodiment.

The accompanying drawings illustrate preferred embodiments of the present disclosure and are provided together with the detailed description for better understanding of the technical idea of the present disclosure. Therefore, the present disclosure should not be construed as being limited to the embodiments set forth in the drawings.

### BEST MODE FOR CARRYING OUT THE INVENTION

The terms used in the embodiments are selected from among common terms that are currently widely used, in consideration of their function in the disclosure. However, the terms may become different according to an intention of one of ordinary skill in the art, a precedent, or the advent of new technology. In addition, in particular cases, the terms are discretionally selected by the applicant. In this instance, the meaning of those terms will be described in detail in the corresponding part of the detailed description. Therefore, the terms used in the disclosure are not merely designations of the terms, but the terms are defined based on the meaning of the terms and content throughout the disclosure.

In the present specification, when a certain part “includes” a certain component, the part does not exclude another component but may further include another component, unless the context clearly dictates otherwise. Also, terms such as “unit,” “module,” etc., as used in the specification may refer to a part for processing at least one function or operation, which may be implemented as hardware, software, or a combination of hardware and software.

Hereinbelow, embodiments of the present disclosure will be described in detail with reference to the accompanying drawings so that the embodiments may be readily implemented by one of ordinary skill in the art to which the present disclosure pertains. However, the present disclosure may be implemented in many different forms and is not limited to the embodiments described herein.

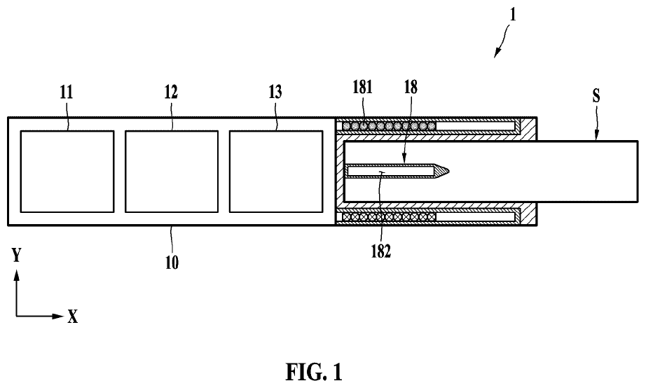

FIG. 1 is a diagram illustrating an aerosol generating device according to an embodiment of the present disclosure.

Referring to FIG. 1, according to an embodiment of the present disclosure, an aerosol generating device 1 may include at least one of a power source 11, a controller 12, a sensor 13, and a heater (a susceptor 18). At least one of the power source 11, the controller 12, the sensor 13, and the susceptor 18 may be arranged inside a body 10 of the aerosol generating device 1. The body 10 may provide a space opened on one side (e.g., an upper side) into which a stick S, an aerosol generating article, is inserted. The space opened on the upper side may be referred to as an insertion space. The insertion space may be recessed by a predetermined depth toward the inside of the body 10 such that at least a portion of the stick S may be inserted into the insertion space. The depth of the insertion space may correspond to a length of an area of the stick S in which an aerosol generating material and/or medium is included. A lower end of the stick S may be inserted into the body 10, and an upper end of the stick S may protrude outward from the body 10. A user may hold the upper end of the stick S, which is exposed to the outside, in the mouth of the user and inhale air.

The susceptor 18 may heat the stick S. The heater may be elongated upward in the space into which the stick S is inserted.

The aerosol generating device 1 may include an induction coil 181 surrounding the susceptor 18, which is the heater. The induction coil 181 may heat the susceptor 18. The susceptor 18 may be heated up by a magnetic field generated by an alternating current (AC) flowing through the induction coil 181. The magnetic field may pass through the susceptor 18 and generate an eddy current in the susceptor 18. A current may generate heat in the susceptor 18.

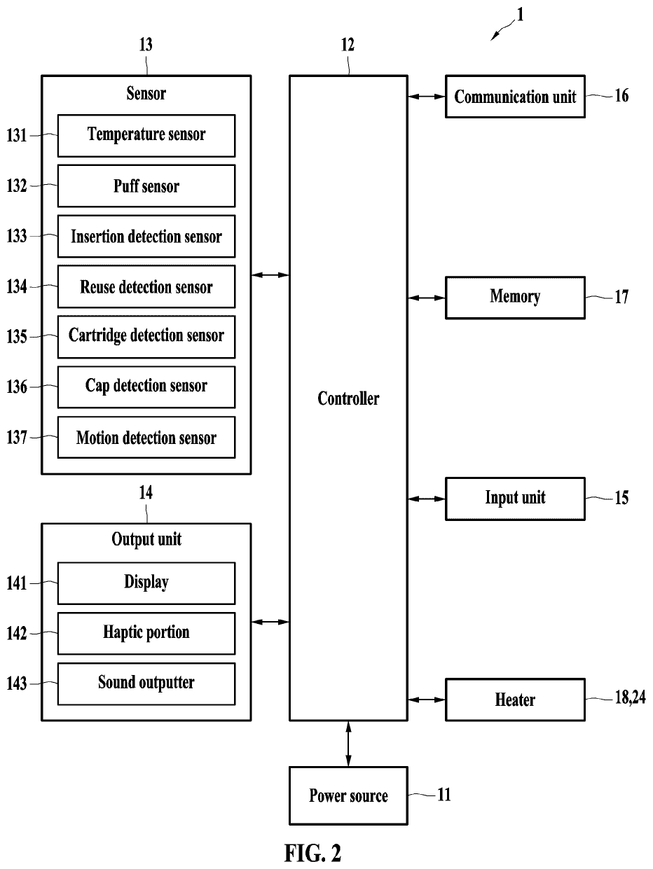

FIG. 2 is a block diagram illustrating an aerosol generating device 1 according to an embodiment of the present disclosure.

The aerosol generating device 1 may include a power source 11, a controller 12, a sensor 13, an output unit 14, an input unit 15, a communication unit 16, a memory 17, and at least one heater 18, 24. However, an internal structure of the aerosol generating device 1 is not limited to what is shown in FIG. 1. It is to be understood by one of ordinary skill in the art to which the disclosure pertains that some of the components shown in FIG. 1 may be omitted or new components may be added according to the design of the aerosol generating device 1.

The sensor 13 may sense a state of the aerosol generating device 1 or a state of an environment around the aerosol generating device 1 and transmit sensed information to the controller 12. Based on the sensed information, the controller 12 may control the aerosol generating device 1 to control operations of the cartridge heater 24 and/or the heater 18, restrict smoking, determine whether the stick S and/or a cartridge 19 is inserted, display a notification, and perform other functions.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may sense a temperature at which the cartridge heater 24 and/or the heater 18 is heated. The aerosol generating device 1 may include a separate temperature sensor to sense the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element whose resistance value changes in response to a change in the temperature of the cartridge heater 24 and/or the heater 18. The temperature sensor 131 may be implemented by a thermistor, which is an element that uses the property that the resistance changes depending on the temperature. At this time, the temperature sensor 131 may output a signal corresponding to the resistance value of the resistive element as the signal corresponding to the temperature of the cartridge heater 24 and/or the heater 18. For example, the temperature sensor 131 may be configured as a sensor for detecting the resistance value of the cartridge heater 24 and/or the heater 18. At this time, the temperature sensor 131 may output a signal corresponding to the resistance value of the cartridge heater 24 and/or the heater 18 as the signal corresponding to the temperature of the cartridge heater 24 and/or the heater 18.

The temperature sensor 131 may be arranged around the power source 11 to monitor the temperature of the power source 11. The temperature sensor 131 may be arranged adjacent to the power source 11. For example, the temperature sensor 131 may be attached to one surface of a battery, which is the power source 11. For example, the temperature sensor 131 may be mounted on one surface of a printed circuit board (PCB).

The temperature sensor 131 may be arranged inside the body 10 to sense the internal temperature of the body 10.

The puff sensor 132 may sense a puff from a user based on various physical changes in an airflow path. The puff sensor 132 may output a signal corresponding to the puff. For example, the puff sensor 132 may be a pressure sensor. The puff sensor 132 may output a signal corresponding to the internal pressure of the aerosol generating device 1. Here, the internal pressure of the aerosol generating device 1 may correspond to the pressure in an airflow path through which a gas flows. The puff sensor 132 may be arranged corresponding to the airflow path through which a gas flows in the aerosol generating device 1.

The insertion detection sensor 133 may sense the insertion and/or removal of the stick S. The insertion detection sensor 133 may sense a signal change according to the insertion and/or removal of the stick S. The insertion detection sensor 133 may be installed in the vicinity of an insertion space. The insertion detection sensor 133 may sense the insertion and/or removal of the stick S according to a change in the permittivity inside the insertion space. For example, the insertion detection sensor 133 may be an inductive sensor and/or a capacitance sensor.

The inductive sensor may include at least one coil. The coil of the inductive sensor may be arranged adjacent to the insertion space. For example, if the magnetic field changes around the coil through which an electric current flows, the properties of the current flowing through the coil may change according to Faraday's law of electromagnetic induction. Here, the properties of the current flowing through the coil may include the frequency of alternating current, the current value, the voltage value, the inductance value, the impedance value, and the like.

The inductive sensor may output a signal corresponding to the properties of the current flowing through the coil. For example, the inductive sensor may output a signal corresponding to the inductance value of the coil.

The capacitance sensor may include a conductor. The conductor of the capacitance sensor may be arranged adjacent to the insertion space. The capacitance sensor may output a signal corresponding to the electromagnetic properties of the surroundings, for example, the capacitance around the conductor. For example, when the stick S including a metal wrapper is inserted into the insertion space, the electromagnetic properties around the conductor may change due to the wrapper of the stick S.

The reuse detection sensor 134 may sense whether the stick S is reused. The reuse detection sensor 134 may be a color sensor. The color sensor may sense the color of the stick. The color sensor may sense the color of a portion of the wrapper that wraps around the outside of the stick S. The color sensor may detect a value of the optical properties corresponding to the color of an object based on light reflected from the object. For example, the optical properties may be the wavelength of light. The color sensor may be implemented as a single component in conjunction with a proximity sensor, or may be implemented as a separate component different from the proximity sensor.

At least a portion of the wrapper of the stick S may change in color due to an aerosol. The reuse detection sensor 134 may be arranged at a position corresponding to the position at which at least a portion of the wrapper that changes in color due to an aerosol is arranged when the stick S is inserted into the insertion space. For example, before the stick S is used by the user, the color of at least a portion of the wrapper may be a first color. At this time, as at least a portion of the wrapper is wet by the aerosol while the aerosol generated by the aerosol generating device 1 passes through the stick S, the color of the at least a portion of the wrapper may change to a second color. Meanwhile, the color of the at least a portion of the wrapper may be maintained as the second color after changing from the first color to the second color.

The cartridge detection sensor 135 may sense the mounting and/or removal of the cartridge 19. The cartridge detection sensor 135 may be implemented by an inductance-based sensor, a capacitive sensor, a resistance sensor, or a Hall sensor (e.g., Hall IC) using the Hall effect.

The cap detection sensor 136 may sense the mounting and/or removal of a cap. When the cap is detached from the body 10, a portion of the cartridge 19 and the body 10 covered by the cap may be exposed to the outside. The cap detection sensor 136 may be implemented by a contact sensor, a Hall sensor (e.g., Hall IC), an optical sensor, or the like.

The motion detection sensor 137 may sense a motion of the aerosol generating device 1. The motion detection sensor 137 may be implemented by at least one of an acceleration sensor and a gyro sensor.

In addition to the sensors 131 to 137 described above, the sensor 13 may further include at least one of a humidity sensor, a barometric pressure sensor, a magnetic sensor, a position sensor (e.g., global positioning system (GPS)), and a proximity sensor. A function of each of the sensors may be intuitively inferable from its name by one of ordinary skill in the art, and thus, a more detailed description thereof will be omitted here.

The output unit 14 may output information about the state of the aerosol generating device 1 and provide the information to the user. The output unit 14 may include at least one of a display 141, a haptic portion 142, or a sound outputter 143, but is not limited thereto. When the display 141 and a touchpad are provided in a layered structure to form a touchscreen, the display 141 may be used as an input device in addition to an output device.

The display 141 may visually provide information about the aerosol generating device 1 to the user. The information about the aerosol generating device 1 may include, for example, a charging/discharging state of the power source 11 of the aerosol generating device 1, a preheating state of the heater 18, an insertion/removal state of the stick S and/or the cartridge 19, a mounting/removal state of the cap, or a limited usage state (e.g., an abnormal article detected) of the aerosol generating device 1, or the like, and the display 141 may externally output the information. For example, the display 141 may be in a form of a light-emitting diode (LED) device. The display 141 may be, for example, a liquid-crystal display panel (LCD), an organic light-emitting display panel (OLED), or the like.

The haptic portion 142 may provide the information about the aerosol generating device 1 to the user in a haptic way by converting an electrical signal into a mechanical stimulus or an electrical stimulus. For example, the haptic portion 142 may generate vibrations corresponding to the completion of initial preheating when initial power is supplied to the cartridge heater 24 and/or the heater 18 for a set time. The haptic portion 142 may include, for example, a vibration motor, a piezoelectric element, or an electrical stimulation device.

The sound outputter 143 may provide the information about the aerosol generating device 1 to the user in an auditory way. For example, the sound outputter 143 may convert an electrical signal into a sound signal and externally output the sound signal.

The power source 11 may supply power to be used to operate the aerosol generating device 1. The power source 11 may supply power to heat the cartridge heater 24 and/or the heater 18. In addition, the power source 11 may supply power required for operations of the other components (e.g., the sensor 13, the output unit 14, the input unit 15, the communication unit 16, and the memory 17) included in the aerosol generating device 1. The power source 11 may be a rechargeable battery or a disposable battery. The power source 11 may be, for example, a lithium polymer (LiPoly) battery but is not limited thereto.

Although not shown in FIG. 2, the aerosol generating device 1 may further include a power protection circuit. The power protection circuit may be electrically connected to the power source 11 and may include a switching element.

The power protection circuit may cut off an electrical circuit for the power source 11 under a predetermined condition. For example, the power protection circuit may cut off the electrical circuit for the power source 11 when the voltage level of the power source 11 is greater than or equal to a first voltage corresponding to overcharging. For example, the power protection circuit may cut off the electrical circuit for the power source 11 when the voltage level of the power source 11 is less than a second voltage corresponding to overdischarging.

The heater 18 may receive power from the power source 11 to heat a medium or an aerosol generating material in the stick S. Although not shown in FIG. 2, the aerosol generating device 1 may further include a power conversion circuit (e.g., a direct current (DC)-to-DC (DC/DC) converter) that converts power of the power source 11 and supplies the power to the cartridge heater 24 and/or the heater 18. In addition, when the aerosol generating device 1 generates an aerosol in an induction heating manner, the aerosol generating device 1 may further include a DC-to-AC (DC/AC) converter that converts DC power of the power source 11 into AC power.

The controller 12, the sensor 13, the output unit 14, the input unit 15, the communication unit 16, and the memory 17 may receive power from the power source 11 to perform functions. Although not shown in FIG. 2, a power conversion circuit, for example, a low dropout (LDO) circuit or a voltage regulator circuit, which converts power of the power source 11 and supplies the power to respective components, may further be included. In addition, although not shown in FIG. 2, a noise filter may be provided between the power source 11 and the heater 18. The noise filter may be a low-pass filter. The low-pass filter may include at least one inductor and at least one capacitor. The cutoff frequency of the low-pass filter may correspond to the frequency of a high-frequency switching current applied from the power source 11 to the heater 18. The low-pass filter may prevent the application of a high-frequency noise component to the sensor 13, such as the insertion detection sensor 133.

In an embodiment, the cartridge heater 24 and/or the heater 18 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 18 may be implemented as a metal heating wire, a metal heating plate on which an electrically conductive track is arranged, a ceramic heating element, or the like, but is not limited thereto.

In another embodiment, the heater 18 may be an induction heater. For example, the heater 18 may include a susceptor that heats the aerosol generating material by generating heat through a magnetic field applied by a coil.

The input unit 15 may receive information input from the user or may output information to the user. For example, the input unit 15 may be a touch panel. The touch panel may include at least one touch sensor for sensing a touch. For example, the touch sensor may include a capacitive touch sensor, a resistive touch sensor, a surface acoustic wave touch sensor, an infrared touch sensor, and the like, but is not limited thereto.

The display 141 and the touch panel may be implemented as a single panel. For example, the touch panel may be inserted into the display 141 (e.g., an on-cell type or in-cell type). For example, the touch panel may be added onto the display panel 141 (e.g., an add-on type).

Meanwhile, the input unit 15 may include a button, a keypad, a dome switch, a jog wheel, a jog switch, and the like, but is not limited thereto.

The memory 17, which is hardware for storing various pieces of data processed in the aerosol generating device 1, may store data processed by the controller 12 and data to be processed by the controller 12. The memory 17 may include at least one type of storage medium of flash memory-type memory, hard disk-type memory, multimedia card micro-type memory, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, or an optical disk. The memory 17 may store an operating time of the aerosol generating device 1, a maximum number of puffs, a current number of puffs, at least one temperature profile, data associated with a smoking pattern of the user, or the like.

The communication unit 16 may include at least one component for communicating with another electronic device. For example, the communication unit 16 may include at least one of a short-range wireless communication unit and a wireless communication unit.

The short-range wireless communication unit may include a Bluetooth communication unit, a Bluetooth low energy (BLE) communication unit, a near-field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+communication unit, but is not limited thereto.

The wireless communication unit may include, for example, a cellular network communication unit, an Internet communication unit, a computer network (e.g., a LAN or a wide-area network (WAN)) communication unit, and the like but is not limited thereto.

Although not shown in FIG. 2, the aerosol generating device 1 may further include a connection interface such as a universal serial bus (USB) interface and may be connected to another external device through the connection interface such as a USB interface to transmit and receive information or to charge the power source 11.

The controller 12 may control the overall operation of the aerosol generating device 1. In an embodiment, the controller 12 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

The controller 12 may control the temperature of the heater 18 by controlling the supply of power from the power source 11 to the heater 18. The controller 12 may control the temperature of the cartridge heater 24 and/or the heater 18 based on the temperature of the cartridge heater 24 and/or the heater 18 sensed by the temperature sensor 131. The controller 12 may adjust the power supplied to the cartridge heater 24 and/or the heater 18 based on the temperature of the cartridge heater 24 and/or the heater 18. For example, the controller 12 may determine a target temperature for the cartridge heater 24 and/or the heater 18 based on a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or the induction coil 181. The power supply circuit may contain at least one switching element. The switching element may be implemented by a bipolar junction transistor (BJT), a field effective transistor (FET), or the like. The controller 12 may control the power supply circuit.

The controller 12 may control the power supply by controlling the switching of the switching element of the power supply circuit. The power supply circuit may be an inverter for converting DC power output from the power source 11 into AC power. For example, the inverter may be configured as a half-bridge circuit or a full-bridge circuit including a plurality of switching elements.

The controller 12 may turn on the switching element to supply power from the power source 11 to the cartridge heater 24 and/or the heater 18. The controller 12 may turn off the switching element to cut off the supply of power to the cartridge heater 24 and/or the heater 18. The controller 12 may adjust the current supplied from the power source 11 by adjusting the frequency and/or duty ratio of the current pulse input to the switching element.

The controller 12 may control the voltage output from the power source 11 by controlling the switching of the switching element of the power supply circuit. A power conversion circuit may convert the voltage output from the power source 11. For example, the power conversion circuit may include a buck-converter for decreasing the voltage output from the power source 11. For example, the power conversion circuit may be implemented through a buck-boost converter, a Zener diode, or the like.

The controller 12 may adjust the level of voltage output from the power conversion circuit by controlling an ON/OFF operation of the switching element included in the power conversion circuit. During the ON state of the switching element, the level of voltage output from the power conversion circuit may correspond to the level of voltage output from the power source 11. The duty ratio for the ON/OFF operation of the switching element may correspond to the ratio of the voltage output from the power conversion circuit to the voltage output from the power source 11. As the duty ratio for the ON/OFF operation of the switching element decreases, the level of voltage output from the power conversion circuit may decrease. The heater 18 may be heated based on the voltage output from the power conversion circuit.

The controller 12 may control to supply power to the heater 18 using at least one of a pulse width modulation (PWM) scheme and a proportional-integral-differential (PID) scheme.

For example, the controller 12 may control to supply a current pulse with a predetermined frequency and a duty ratio to the heater 18, using the PWM scheme. The controller 12 may control the power supplied to the heater 18 by adjusting the frequency and duty ratio of the current pulse.

For example, the controller 12 may determine a target temperature, the target of the controlling, based on the temperature profile. The controller 12 may control the power supplied to the heater 18 using the PID scheme, which is a feedback control scheme through the difference value between the temperature of the heater 18 and the target temperature, the value obtained by integrating the difference value over time, and the value obtained by differentiating the difference value over time.

The controller 12 may prevent overheating of the cartridge heater 24 and/or the heater 18. For example, the controller 12 may control the operation of the power conversion circuit to stop supplying power to the cartridge heater 24 and/or the heater 18 based on the temperature of the cartridge heater 24 and/or the heater 18 exceeding a preset temperature limit. For example, the controller 12 may reduce the amount of power supplied to the cartridge heater 24 and/or the heater 18 by a predetermined proportion, based on the temperature of the cartridge heater 24 and/or the heater 18 exceeding the preset temperature limit. For example, the controller 12 may determine that the aerosol generating material accommodated in the cartridge 19 is exhausted based on the temperature of the cartridge heater 24 exceeding the temperature limit, and cut off the power supply to the cartridge heater 24.

The controller 12 may control the charging and discharging of the power source 11. The controller 12 may verify the temperature of the power source 11 based on an output signal from the temperature sensor 131.

When a power line is connected to a battery terminal of the aerosol generating device 1, the controller 12 may verify whether the temperature of the power source 11 is greater than or equal to a first temperature limit which is the criterion for cutting off the charging of the power source 11. The controller 12 may control the power source 11 to be charged based on a preset charging current when the temperature of the power source 11 is less than the first temperature limit. The controller 12 may cut off the charging of the power source 11 when the temperature of the power source 11 is greater than or equal to the first temperature limit.

In a state in which the aerosol generating device 1 is powered on, the controller 12 may verify whether the temperature of the power source 11 is greater than or equal to a second temperature limit which is the criterion for cutting off the discharging of the power source 11. The controller 12 may control the power stored in the power source 11 to be used when the temperature of the power source 11 is less than the second temperature limit. The controller 12 may stop using the power stored in the power source 11 when the temperature of the power source 11 is greater than or equal to the second temperature limit.

The controller 12 may calculate the remaining capacity for the power stored in the power source 11. For example, the controller 12 may calculate the remaining capacity of the power source 11 based on the voltage of the power source 11 and/or the value of current sensed.

The controller 12 may determine whether the stick S is inserted into the insertion space through the insertion detection sensor 133. The controller 12 may determine that the stick S is inserted based on an output signal from the insertion detection sensor 133. When it is determined that the stick S is inserted into the insertion space, the controller 12 may control to supply power to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space through the insertion detection sensor 133. For example, the controller 12 may determine that the stick S is removed from the insertion space when the temperature of the heater 18 is greater than or equal to a temperature limit or when the gradient of the temperature change of the heater 18 is greater than or equal to a set gradient. When it is determined that the stick S is removed from the insertion space, the controller 12 may cut off the supply of power to the cartridge heater 24 and/or the heater 18.

The controller 12 may control the time of power supply and/or the amount of power supply to the heater 18 depending on the state of the stick S sensed by the sensor 13. The controller 12 may verify a level range including the level of a signal of the capacitance sensor based on a lookup table. The controller 12 may determine the amount of moisture in the stick S according to the verified level range.

When the stick S is in an over-humidified state, the controller 12 may increase the preheating time of the stick S compared to the case in which the stick S is in a normal state, by controlling the time of power supply to the heater 18.

The controller 12 may determine whether the stick S inserted into the insertion space is reused through the reuse detection sensor 134. For example, the controller 12 may compare a sensed value of a signal of the reuse detection sensor with a first reference range including a first color, and when the sensed value falls within the first reference range, determine that the stick S is unused. For example, the controller 12 may compare the sensed value of the signal of the reuse detection sensor with a second reference range including a second color, and when the sensed value falls within the second reference range, determine that the stick S is used. When it is determined that the stick S is used, the controller 12 may cut off the supply of power to the cartridge heater 24 and/or the heater 18.

The controller 12 may determine whether the cartridge 19 is coupled and/or decoupled, through the cartridge detection sensor 135. For example, the controller 12 may determine whether the cartridge 19 is coupled and/or decoupled based on a sensed value of a signal of the cartridge detection sensor.

The controller 12 may determine whether the aerosol generating material in the cartridge 19 is exhausted. For example, the controller 12 may preheat the cartridge heater 24 and/or the heater 18 by applying power, determine whether the temperature of the cartridge heater 24 exceeds the temperature limit in a preheating period, and determine that the aerosol generating material in the cartridge 19 is exhausted when the temperature of the cartridge heater 24 exceeds the temperature limit. When it is determined that the aerosol generating material in the cartridge 19 is exhausted, the controller 12 may cut off the supply of power to the cartridge heater 24 and/or the heater 18.

The controller 12 may determine whether the cartridge 19 is usable. For example, the controller 12 may determine that the cartridge 19 is unusable when the current number of puffs is greater than or equal to the maximum number of puffs set in the cartridge 19 based on the data stored in the memory 17. For example, the controller 12 may determine that the cartridge 19 is unusable when the total time for which the heater 24 is heated is greater than or equal to a preset maximum time or when the total amount of power supplied to the heater 24 is greater than or equal to a preset maximum amount of power.

The controller 12 may perform a determination about the inhalation of the user through the puff sensor 132. For example, the controller 12 may determine whether a puff occurs based on a sensed value of a signal of the puff sensor. For example, the controller 12 may determine the strength of the puff based on the sensed value of the signal of the puff sensor 132. When the number of puffs reaches the preset maximum number of puffs or when a puff is not detected for more than a preset time, the controller 12 may cut off the supply of power to the cartridge heater 24 and/or the heater 18.

The controller 12 may determine whether the cap is put on and/or taken off, through the cap detection sensor 136. For example, the controller 12 may determine whether the cap is put on and/or taken off based on a sensed value of a signal of the cap detection sensor.

The controller 12 may control the output unit 14 based on a result of sensing by the sensor 13. For example, when the number of puffs counted through the puff sensor 132 reaches a preset number, the controller 12 may inform the user that the aerosol generating device 1 is to be ended soon, through at least one of the display 141, the haptic portion 142, or the sound outputter 143. For example, the controller 12 may inform the user through the output unit 14 based on the determination that the stick S is absent from the insertion space. For example, the controller 12 may inform the user through the output unit 14 based on the determination that the cartridge 19 and/or the cap is not mounted. For example, the controller 12 may provide information on the temperature of the cartridge heater 24 and/or the heater 18 to the user through the output unit 14.

Based on the occurrence of a predetermined event, the controller 12 may store and update the history of the event that occurred in the memory 17. The event may include the detection of inserting the stick S, the initiation of heating the stick S, the detection of puffs, the end of puffs, the detection of overheating of the cartridge heater 24 and/or the heater 18, the detection of applying overvoltage to the cartridge heater 24 and/or the heater 18, the end of heating the stick S, the operation of powering ON/OFF the aerosol generating device 1, initiation of charging the power source 11, the detection of overcharging of the power source 11, the end of charging the power source 11, or the like, performed by the aerosol generating device 1. The history of the event may include the date and time the event occurred, log data corresponding to the event, and the like. For example, when the predetermined event is the detection of inserting the stick S, the log data corresponding to the event may include data on the sensed value of the insertion detection sensor 133. For example, when the predetermined event is the detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, the current flowing in the cartridge heater 24 and/or the heater 18, and the like.

The controller 12 may control to form a communication link with an external device, such as a mobile terminal of the user. When authentication data is received from the external device via the communication link, the controller 12 may remove restrictions on the use of at least one function of the aerosol generating device 1. Here, the authentication data may include data indicating the completion of user authentication for the user corresponding to the external device. The user may perform user authentication through the external device. The external device may determine whether user data is valid based on the date of birth of the user, a unique number that identifies the user, and the like and receive data on the authority to use the aerosol generating device 1 from an external server. The external device may transmit data indicating the completion of user authentication to the aerosol generating device 1 based on the data on the authority to use. In response to the completion of the user authentication, the controller 12 may remove restrictions on the use of at least one function of the aerosol generating device 1. For example, in response to the completion of the user authentication, the controller 12 may remove restrictions on the use of a heating function that supplies power to the heater 18.

The controller 12 may transmit state data of the aerosol generating device 1 to the external device via the communication link with the external device. Based on the received state data, the external device may output the remaining capacity, the operation mode, and the like of the power source 11 of the aerosol generating device 1 through a display of the external device.

The external device may transmit a location search request to the aerosol generating device 1 based on an input that initiates a search for the location of the aerosol generating device 1. When the location search request is received from the external device, the controller 12 may control at least one of output devices to perform an operation corresponding to the location search based on the received location search request. For example, in response to the location search request, the haptic portion 142 may generate vibrations. For example, in response to the location search request, the display 141 may output an object corresponding to the location search and the end of the search.

When firmware data is received from the external device, the controller 12 may control to perform a firmware update. The external device may check the current version of the firmware for the aerosol generating device 1 and determine whether a new version of the firmware is present. When an input that requests a firmware download is received, the external device may receive a new version of firmware data and transmit the new version of firmware data to the aerosol generating device 1. When the new version of firmware data is received, the controller 12 may control to update the firmware of the aerosol generating device 1.

The controller 12 may transmit data on the sensed value of at least one sensor 13 through the communication unit 16 to an external server (not shown), receive a training model generated by being trained with the sensed value through machine learning such as deep learning from the server, and store the training model. The controller 12 may perform an operation of determining an inhalation pattern of the user, an operation of generating a temperature profile, and the like using the training model received from the server. The controller 12 may store, in the memory 17, the sensed value data of at least one sensor 13 and the data used to train an artificial neural network (ANN). For example, the memory 17 may store a database for each component provided in the aerosol generating device 1, weights that form the structure of the ANN, and biases, for training the ANN. The controller 12 may generate at least one training model that learns the data on the sensed value of at least one sensor 13, the inhalation pattern of the user, the temperature profile, and the like, stored in the memory 17, and is used to determine the inhalation pattern of the user and generate the temperature profile.

In an embodiment, the aerosol generating device 1 may further include a detection unit 23. The detection unit 23 may include a red, green, and blue (RGB) sensor that may detect color or tone. For example, the detection unit 23 may include a light-emitting sensor and a light-receiving sensor facing an outer surface of the stick S, and the light-emitting sensor and the light-receiving sensor may be arranged to face the insertion space of the body 10 and/or may be arranged at an upper end of the body 10 to face the stick S exposed to the outside of the body 10.

Referring again to FIG. 1, the susceptor 18 may include a hollow portion 182 for increasing inductance generated when the susceptor 18 is heated.

In an embodiment, the susceptor 18 may include a rod protruding toward an opening of an internal space (insertion space). The rod may protrude upward from an end of the internal space. For example, the rod may be configured as any one of a tubular, plate-shaped, needle-shaped or rod-shaped rod.

The hollow portion 182 may be formed inside the rod along a longitudinal direction (e.g., an X direction of FIG. 1) of the rod. Since the susceptor 18 has the hollow portion 182, the width of the susceptor 18 may be increased as the susceptor 18 is heated. Here, the width of the susceptor 18 may be defined as the length in a direction (e.g., a Y direction of FIG. 1) perpendicular to a longitudinal direction of the susceptor 18.

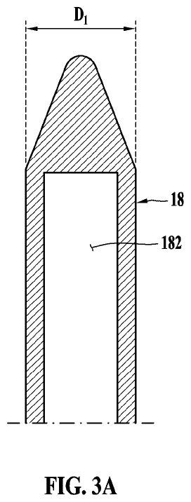

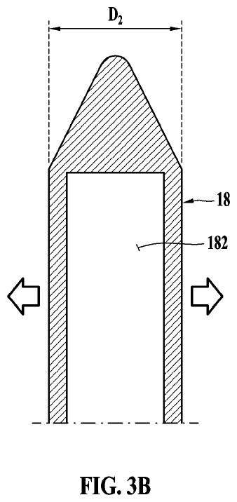

FIGS. 3A and 3B are schematic diagrams illustrating a cross-section of the susceptor 18 of the aerosol generating device 1, according to an embodiment. FIG. 3A represents a state before the susceptor 18 is heated, and FIG. 3B represents a state in which the susceptor 18 is heated and the temperature is increased.

Referring to FIG. 3A, the susceptor 18 may include the hollow portion 182 therein, and before heating, the susceptor 18 may have a first width D1. Referring to FIG. 3B, when the susceptor 18 is heated by the induction coil 181, the width of the susceptor 18 may be increased as the susceptor 18 expands by the hollow portion 182. Here, the susceptor 18 may have a second width D2, and the second width D2 may be greater than the first width D1.

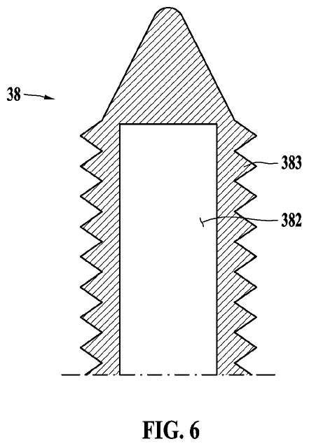

When the temperature of the susceptor 18 increases, inductance and/or resistance of the susceptor 18 may increase. As the inductance of the susceptor 18 increases, a natural frequency of the susceptor 18 at the corresponding temperature may decrease. When the natural frequency of the susceptor 18 is lowered, an eddy current trajectory appearing at room temperature may have an effect of being shifted to the left with respect to a frequency axis. Accordingly, the amount of current change may increase, and the accuracy of temperature measurement may be improved. Due to the hollow portion 182 of the susceptor 18, the second width D2 of the susceptor 18 may be greatly increased, and due to the increased second width D2 of the susceptor 18, the inductance of the susceptor 18 may be greatly increased compared to the susceptor 18 having the first width D1. This is described in detail with reference to FIG. 6.

In an embodiment, the susceptor 18 may include a magnetic material. For example, the susceptor 18 may include a ferromagnetic material. The inductance of the susceptor 18 may change due to magnetic change caused by heat.

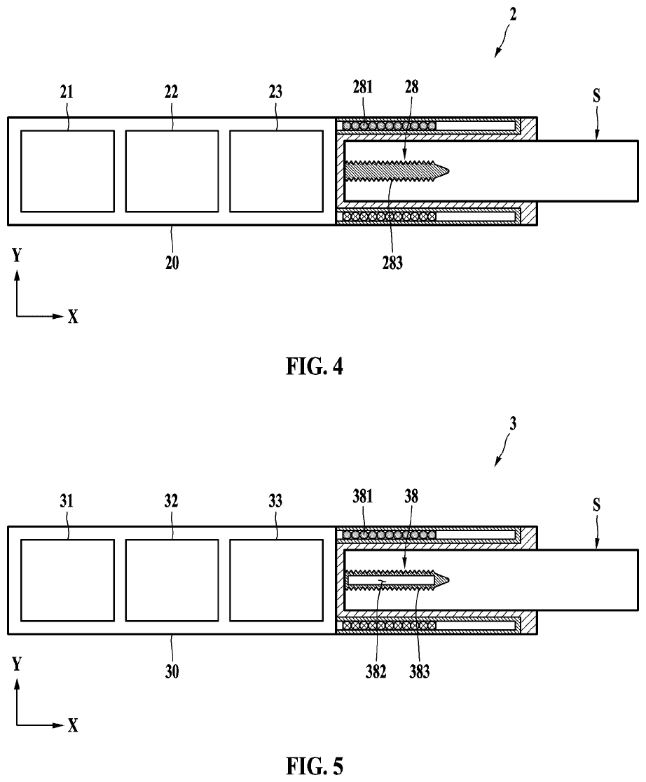

FIG. 4 is a diagram illustrating an aerosol generating device 2 according to an embodiment.

The aerosol generating device 2 may include at least one of a power source 21, a controller 22, a sensor 23, and a heater (a susceptor 28). At least one of the power source 21, the controller 22, the sensor 23, and the susceptor 28 may be arranged inside a body 20 of the aerosol generating device 2. The body 20 may provide a space opened on one side (e.g., an upper side) into which the stick S, an aerosol generating article, is inserted. The susceptor 28 may heat the stick S. The aerosol generating device 2 may include an induction coil 281 surrounding the susceptor 28, which is the heater.

In an embodiment, the susceptor 28 may include screw threads 283 on a surface of the susceptor 28, and inductance generation may be increased when the susceptor 28 is heated by the screw threads 283.

The susceptor 28 may include a rod protruding toward an opening of the internal space, and the screw threads 283 may be formed on an outer surface of the rod along a longitudinal direction (e.g., an X direction of FIG. 4) of the rod.

When a current is generated in the susceptor 28 by the induction coil 281, the current may flow a lot along an outer surface of the susceptor 28 due to a skin effect. Here, since the current flows along the screw threads 283 formed on the outer surface of the susceptor 28, the current may flow along the longitudinal direction while circling an outer circumference of the susceptor 28. This may be simulated by the current flowing through a coil, and the number of turns of the screw threads may correspond to the number of turns of the coil.

Compared to a case without the screw threads 283, the susceptor 28 having the screw threads 283 may increase inductance through the skin effect of an induction current. As the inductance increases, the amount of current change may increase, and the accuracy of temperature measurement may be improved.

FIG. 5 is a diagram illustrating an aerosol generating device 3 according to an embodiment.

The aerosol generating device 3 may include at least one of a power source 31, a controller 32, a sensor 33, and a heater (a susceptor 38). At least one of the power source 31, the controller 32, the sensor 33, and the susceptor 38 may be arranged inside a body 30 of the aerosol generating device 3. The body 30 may provide a space opened on one side (e.g., an upper side) into which the stick S, an aerosol generating article, is inserted. The susceptor 38 may heat the stick S. The aerosol generating device 3 may include an induction coil 381 surrounding the susceptor 38, which is the heater.

In an embodiment, the susceptor 38 may include a hollow portion 382 for increasing inductance generated when the susceptor 38 is heated and screw threads 383 formed on a surface of the susceptor 38. The hollow portion 382 of the susceptor 38 may increase the width of the susceptor 38 when the susceptor 38 is heated, thereby increasing the inductance of the susceptor 38. The screw threads 383 of the susceptor 38 may also increase the inductance generated when the susceptor 38 is heated.

FIG. 6 is a schematic diagram illustrating a cross-section of the susceptor 38 of the aerosol generating device 3, according to an embodiment. Referring to FIG. 6, since the susceptor 38 has both the hollow portion 382 and the screw threads 383, an increase in the inductance may be maximized when the susceptor 38 is heated.

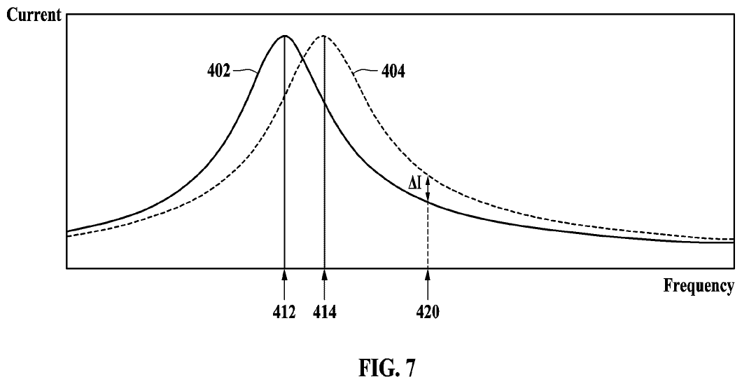

FIG. 7 is a diagram illustrating an eddy current trajectory in a susceptor represented by a frequency of a signal, according to an embodiment.

Since the susceptor is electrically separated from an induction coil, it may be difficult to directly measure the temperature of the susceptor. In this case, the temperature of the susceptor may be estimated through a current.

According to an embodiment, electrical properties 404 represented by the susceptor before heating may be different to electrical properties 402 represented by the heated susceptor. For example, since a first natural frequency 414 of the susceptor before heating is different to a natural frequency 412 of the heated susceptor, a first eddy current trajectory 404 of the susceptor before heating, represented by a frequency of a provided signal, may be different to a second eddy current trajectory 402 of the heated susceptor.

When the temperature of the susceptor increases, inductance and/or resistance of the susceptor may increase. As the inductance of the susceptor increases, a natural frequency of the susceptor at the corresponding temperature may decrease. When the natural frequency of the susceptor is lowered, a trajectory of an eddy current appearing at room temperature may have an effect of being shifted to the left with respect to a frequency axis. Accordingly, an eddy current value in the heated susceptor may decrease compared to an eddy current value in the susceptor before heating (at room temperature). At a specific frequency 420, an eddy current trajectory may shift to the left, causing a current change ΔI, and since a temperature change is proportional to the current change ΔI, a large current change ΔI may cause a large temperature change, thereby increasing accuracy of temperature measurement.

A degree Δf to which the eddy current trajectory shifts to the left with respect to the frequency axis may be proportional to an increase in inductance of the susceptor.

As described above, when the susceptor 18 according to an embodiment includes the hollow portion 182, when the susceptor 28 according to an embodiment includes the screw threads 283, or when the susceptor 38 according to an embodiment includes the hollow portion 382 and the screw threads 383, the inductance of the susceptor 18, 28, 38 may increase when heated, so that the degree Δf to which the eddy current trajectory shifts to the left with respect to the frequency axis may increase, and accordingly, the current change ΔI may increase and the temperature change may increase, thereby increasing the accuracy of temperature measurement of the susceptor.

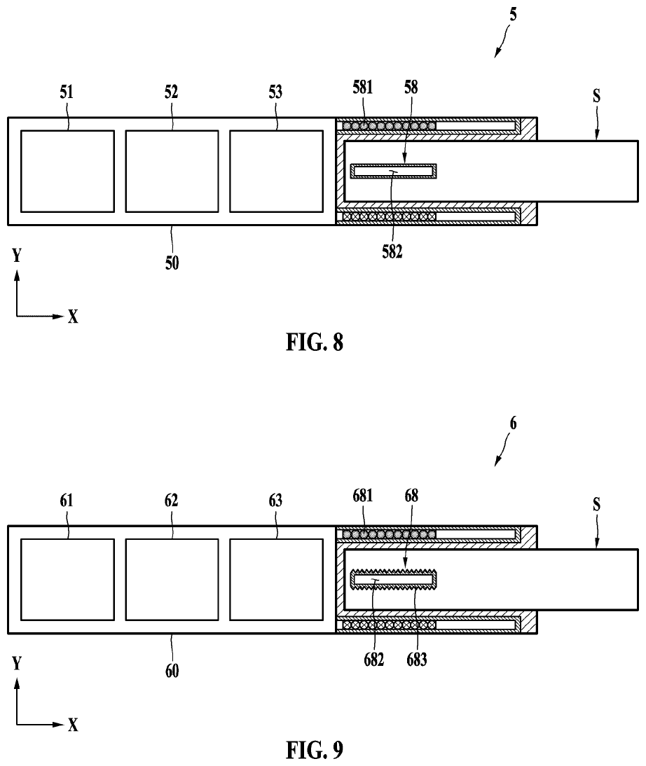

FIG. 8 is a diagram illustrating an aerosol generating device 5 according to an embodiment.

Referring to FIG. 8, the aerosol generating device 5 may include at least one of a power source 51, a controller 52, a sensor 53, and a heater (a susceptor 58). At least one of the power source 51, the controller 52, the sensor 53, and the susceptor 58 may be arranged inside a body 50 of the aerosol generating device 5. The body 50 may provide a space opened on one side (e.g., an upper side) into which the stick S, an aerosol generating article, is inserted. The aerosol generating device 5 may include an induction coil 581 surrounding the susceptor 58, which is the heater.

The susceptor 58 may be included inside the stick S. The susceptor 58 inside the stick S may be heated by a magnetic field generated by an AC flowing through the induction coil 581. The susceptor 58 may be arranged inside the stick S and may not be electrically connected to the aerosol generating device. The susceptor 58 may be inserted into an insertion space together with the stick S and may be removed from the insertion space together with the stick S. The stick S may be heated by the susceptor 58 inside the stick S. In this case, the heater may not be provided to the aerosol generating device.

In an embodiment, the susceptor 58 may include a rod formed along a longitudinal direction (e.g., an X direction of FIG. 8) of the stick S, and a hollow portion 582 formed along the longitudinal direction of the rod may be formed inside the rod. The hollow portion 582 of the susceptor 58 may increase the width of the susceptor 58 when the susceptor 58 is heated, thereby increasing inductance of the susceptor 58.

FIG. 9 is a diagram illustrating an aerosol generating device 6 according to an embodiment.

Referring to FIG. 9, the aerosol generating device 6 may include at least one of a power source 61, a controller 62, a sensor 63, and a heater (a susceptor 68). At least one of the power source 61, the controller 62, the sensor 63, and the susceptor 68 may be arranged inside a body 60 of the aerosol generating device 6. The body 60 may provide a space opened on one side (e.g., an upper side) into which the stick S, an aerosol generating article, is inserted. The aerosol generating device 6 may include an induction coil 681 surrounding the susceptor 68, which is the heater.

The susceptor 68 may be included inside the stick S. The susceptor 68 inside the stick S may be heated by a magnetic field generated by an AC flowing through the induction coil 681. The susceptor 68 may be arranged inside the stick S and may not be electrically connected to the aerosol generating device. The susceptor 68 may be inserted into an insertion space together with the stick S and may be removed from the insertion space together with the stick S. The stick S may be heated by the susceptor 68 inside the stick S. In this case, the heater may not be provided to the aerosol generating device.

In an embodiment, the susceptor 68 may include a rod formed along a longitudinal direction (e.g., an X direction of FIG. 9) of the stick S, and a hollow portion 682 formed along the longitudinal direction of the rod may be formed inside the rod. Screw threads 683 may be formed on a surface of the rod. The hollow portion 682 of the susceptor 68 may increase the width of the susceptor 68 when the susceptor 68 is heated, thereby increasing inductance of the susceptor 68. The screw threads 683 of the susceptor 68 may also increase the inductance generated when the susceptor 68 is heated.

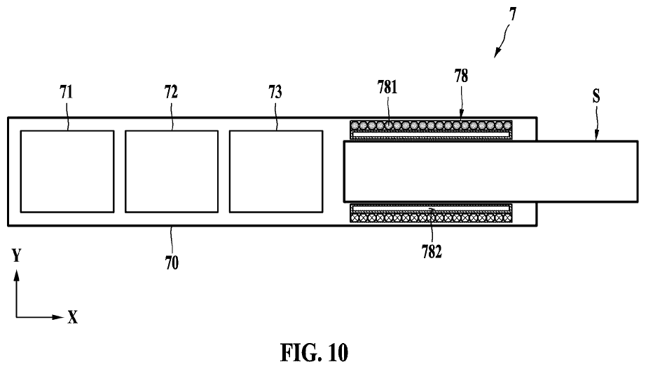

FIG. 10 is a diagram illustrating an aerosol generating device 7 according to an embodiment.

Referring to FIG. 10, the aerosol generating device 7 may include at least one of a power source 71, a controller 72, a sensor 73, and a susceptor 78. At least one of the power source 71, the controller 72, the sensor 73, and the susceptor 78 may be arranged inside a body 70 of the aerosol generating device 7. The body 70 may provide an upward-opening space into which the stick S, an aerosol generating article, is inserted. The susceptor 78 may be elongated upward around the space into which the stick S is inserted. For example, the susceptor 78 may be in the form of a tube including a hollow portion therein. The susceptor 78 may be arranged around an insertion space. The susceptor 78 may be arranged to surround at least a portion of the insertion space. The aerosol generating device 7 may include an induction coil 781 surrounding the susceptor 78. The induction coil 781 may heat the susceptor 78.

In an embodiment, the susceptor 78 may include a hollow portion 782 for increasing inductance generated when the susceptor 78 is heated. The hollow portion 782 of the susceptor 78 may increase the width of the susceptor 78 when the susceptor 78 is heated, thereby increasing the inductance of the susceptor 78.

The aerosol generating device 1, 3, 5, 6, 7 according to an embodiment may include the body 10, 30, 50, 60, 70 having an internal space formed into which an aerosol generating article (the stick S) is inserted on one side, the susceptor 18, 38, 58, 68, 78 accommodated in the body and configured to heat the aerosol generating article, the induction coil 181, 381, 581, 681, 781 surrounding the susceptor and configured to generate an alternating magnetic field, and the controller 12, 32, 52, 62, 72 configured to control an operation of the aerosol generating device and including at least one processor, wherein the susceptor may include the hollow portion 182, 382, 582, 682, 782 configured to increase inductance of the susceptor when heated.

In an embodiment, the susceptor may include a rod accommodated in the internal space, the rod may protrude toward an opening of the internal space, the hollow portion may be formed inside the rod along a longitudinal direction of the rod, and the width of the susceptor may be increased by heating the susceptor.

The rod may have a cylindrical shape.

The screw threads 383, 683 may be formed on a surface of the rod.

The screw threads may be formed along the longitudinal direction of the rod.

In an embodiment, the rod may include a ferromagnetic material.

In an embodiment, the susceptor 58, 68 may be included in the aerosol generating article.

The susceptor may include a rod formed along a longitudinal direction of the aerosol generating article, the hollow portion may be formed inside the rod along the longitudinal direction of the rod, and the width of the susceptor may be increased by heating the susceptor.

The screw threads 683 may be formed on a surface of the rod along the longitudinal direction of the rod.

In an embodiment, the susceptor 78 may be configured to surround at least a portion of an outer side of the internal space and extend along a longitudinal direction of the internal space, the hollow portion 782 may be formed inside the susceptor along a longitudinal direction of the susceptor, and an outer diameter of the susceptor may be increased by heating the susceptor.

The aerosol generating device 2, 3 according to an embodiment may include the body 20, 30 having an internal space formed into which an aerosol generating article (the stick S) is inserted on one side, the susceptor 28, 38 accommodated in the body and configured to heat the aerosol generating article, the induction coil 281, 381 surrounding the susceptor and configured to generate an alternating magnetic field, and the controller 22, 32 configured to control an operation of the aerosol generating device and including at least one processor, wherein the screw threads 283, 383 are formed on a surface of the susceptor so that inductance is increased when the susceptor is heated.

The susceptor may include the hollow portion 382 that increases inductance.

Some embodiments of the disclosure described above or other embodiments are not mutually exclusive or distinct from each other. Some embodiments of the disclosure described above or other embodiments may be used jointly or combined with each other in configuration or function.

For example, a configuration A described in an embodiment and/or drawing and a configuration B described in another embodiment and/or drawing may be combined with each other. Namely, although the combination between the configurations is not directly described, the combination is possible except in cases where it is described that the combination is impossible.

The above detailed description should not be construed in all aspects as limiting and should be considered illustrative. The scope of the present disclosure should be determined by rational interpretation of the appended claims, and all variations within the scope of equivalents of the present disclosure are included in the scope of the present disclosure.

1. An aerosol generating device comprising:
a body having an internal space formed into which an aerosol generating article is inserted on one side;
a susceptor accommodated in the body and configured to heat the aerosol generating article;
an induction coil surrounding the susceptor and configured to generate an alternating magnetic field; and
a controller configured to control an operation of the aerosol generating device and comprising at least one processor,
wherein the susceptor comprises a hollow portion configured to increase inductance of the susceptor when heated.

2. The aerosol generating device of claim 1, wherein
the susceptor comprises a rod accommodated in the internal space, the rod protrudes toward an opening of the internal space, the hollow portion is formed inside the rod along a longitudinal direction of the rod, and
a width of the susceptor perpendicular to the longitudinal direction is increased by heating.

3. The aerosol generating device of claim 2, wherein
the rod has a cylindrical shape.

4. The aerosol generating device of claim 3, wherein
screw threads are formed on a surface of the rod.

5. The aerosol generating device of claim 4, wherein
the screw threads are formed along the longitudinal direction.

6. The aerosol generating device of claim 2, wherein
the rod comprises a ferromagnetic material.

7. The aerosol generating device of claim 1, wherein
the susceptor is comprised in the aerosol generating article.

8. The aerosol generating device of claim 7, wherein
the susceptor comprises a rod formed along a longitudinal direction of the aerosol generating article, the hollow portion is formed inside the rod along the longitudinal direction, and
a width of the susceptor perpendicular to the longitudinal direction is increased by heating.

9. The aerosol generating device of claim 8, wherein
screw threads are formed on a surface of the rod along the longitudinal direction.

10. The aerosol generating device of claim 1, wherein
the susceptor is configured to surround at least a portion of an outer side of the internal space and extend along a longitudinal direction of the internal space,
the hollow portion is formed inside the susceptor along the longitudinal direction, and
an outer diameter of the susceptor is increased by heating.

11. An aerosol generating device comprising:
a body having an internal space formed into which an aerosol generating article is inserted on one side;
a susceptor accommodated in the body and configured to heat the aerosol generating article;
an induction coil surrounding the susceptor and configured to generate an alternating magnetic field; and
a controller configured to control an operation of the aerosol generating device and comprising at least one processor,
wherein screw threads are formed on a surface of the susceptor so that inductance is increased when the susceptor is heated.

12. The aerosol generating device of claim 11, wherein
the susceptor comprises a hollow portion configured to increase inductance.
